(19) United States
(12) Patent Application Publication
(10) Pub. No.: US 2008/0083029 A1
(43) Pub. Date: Apr. 3, 2008

(54) Intelligence Network Anomaly Detection Using A Type II Fuzzy Neural Network

(75) Inventors: Chiang Yeh, Sierra Madre, CA (US); Jeremy Touve, Valencia, CA (US); R. Leon Sangroniz, Sandy, UT (US)

Correspondence Address: ALCATEL LUCENT;(FKA ALCATEL INTERNETWORKING, INC.), INTELLECTUAL PROPERTY & STANDARDS, 3400 W. PLANO PARKWAY, MS LEGL2, PLANO, TX, 75075, US

(73) Assignee: ALCATEL, PARIS (FR)

(21) Appl. No.: 11/536,842

(22) Filed: Sep. 29, 2006

(51) Int. Cl. G06F 12/14; G06F 15/173; G06F 11/00; G06F 12/16; G06F 15/18; G08B 23/00

(52) U.S. Cl. 726/22; 709/224

(57) ABSTRACT

A network device (e.g., layer 3 Ethernet switch) is described herein which interfaces with an anomaly detector that implements a type II fuzzy neural network to track symptoms of an attack (which is directed at a private network) and to suggest escalating corrective actions (which can be implemented by the network device) until the symptoms of the attack begin to disappear.

### TECHNICAL FIELD

The present invention relates to an anomaly detector and a method for using a type II fuzzy neural network to identify symptoms of an attack/anomaly (which is directed at a private network) and to suggest escalating corrective actions (which can be implemented by a network device) until the symptoms of the attack/anomaly begin to disappear.

### BACKGROUND

Current networking devices (e.g., layer 3 Ethernet switch) often use either post mortem technique or preventative measures technique to detect and correct network anomalies/attacks. In the former case, the networking device collects an extensive amount of network statistics and then sends this information to an external facility to identify known patterns or signatures of organized attack/anomalies or undesirable network activities. Since, the requirements of collating, accounting, and analyzing these network statistics demands an exhaustive amount of number crunching and searching capabilities, this external facility identifies the anomaly/attack after it has already damaged the network.

In the latter case, the networking device is programmed with a set of filter masks, decision trees, or complicated heuristics that corresponds to known patterns or signatures of organized attacks/anomalies or undesirable network activities. These mechanisms only recognize the attacks/anomalies by using hard and fast rules which are fairly efficient at tracking fixed and organized patterns of attacks/anomalies. Once identified, the networking device takes appropriate steps to address the symptoms of the offending attacks/anomalies. This particular technique works well if the attack/anomaly has a rigid range of behaviors and leaves a well known signature.

Some networking devices use a combination of the post mortem technique and the preventative measures technique to detect and correct network anomalies/attacks. Since, the most damaging and recognizable attack methods, e.g., denial of service, port scanning, etc., have very distinct signatures, this type of networking device is able to successfully identify and correct many of these attacks/anomalies. For instance, a network administrator can easily program a set of filter masks, decision trees, or complicated heuristics to detect and correct the problems cause by an attack/anomaly which exhibits a rigid range of behaviors and leaves a well known signature. However, the newer types of attacks/anomalies which are commonly used today do not behave in a predictable manner or leave a distinct signature. For example, there is a new generation of worms which have a range of activities that are not easily identifiable when they migrate across a network, because these newer worms use biological algorithms which cause them to transmute their behaviors as they migrate and reproduce within a network.

As a result, these well known techniques may not perform very well because they depend on intimate knowledge about the cause of the attack/anomaly before they can recognize the attack/anomaly and take corrective actions to correct the symptoms of the attack/anomaly. Plus, these techniques often need to take a discrete course of corrective actions regardless of the degree of the attack/anomaly (unless the network administrator specifically defines each degree of the attack that they wish to address, which, in essence, renders each degree of the attack as a new class of attack). Accordingly, there is a need for a new technique which can detect an attack/anomaly (especially one of the newer types of transmutable worms) and suggest escalating actions until the symptoms of the attack/anomaly begin to disappear. This need and other needs are addressed by the anomaly detector and the anomaly detection method of the present invention.

### BRIEF DESCRIPTION OF THE INVENTION

The present invention includes an anomaly detector and a method for using a type II fuzzy neural network that can track symptoms of an attack and suggest escalating corrective actions until the symptoms of the attack begin to disappear. In one embodiment, the anomaly detector uses a three-tiered type II fuzzy neural network where the first tier has multiple membership functions μ₁-μᵢ that collect statistics about different aspects of the “health” of a network device and processes those numbers into metrics which have values between 0 and 1. The second tier has multiple summers Π₁-∪ₘ each of which interfaces with selected membership functions μ₁-μᵢ to obtain their metrics and then outputs a running sum (probabilistic, not numerical). The third tier 206 has multiple aggregators Σ₁-Σₖ each of which aggregates the sums from selected summers ∪₁-Πₘ and computes a running average that is compared to fuzzy logic control rules (located within an if-then-else table) to determine a particular course of action which the network device can follow to address the symptoms of an attack.

### BRIEF DESCRIPTION OF THE DRAWINGS

A more complete understanding of the present invention may be obtained by reference to the following detailed description when taken in conjunction with the accompanying drawings wherein:

FIG. 1 is a diagram of a network device which interacts with an anomaly detector that functions to protect a private network in accordance with the present invention;

FIG. 2 is a diagram of the anomaly detector that uses a three-tiered type II fuzzy neural network to protect the private network in accordance with one embodiment of the present invention; and

FIG. 3 is a diagram illustrating the basic steps that can be performed by the anomaly detector which uses the three-tiered type II fuzzy neural network in order to protect the private network in accordance with one embodiment of the present invention.

### DETAILED DESCRIPTION OF THE DRAWINGS

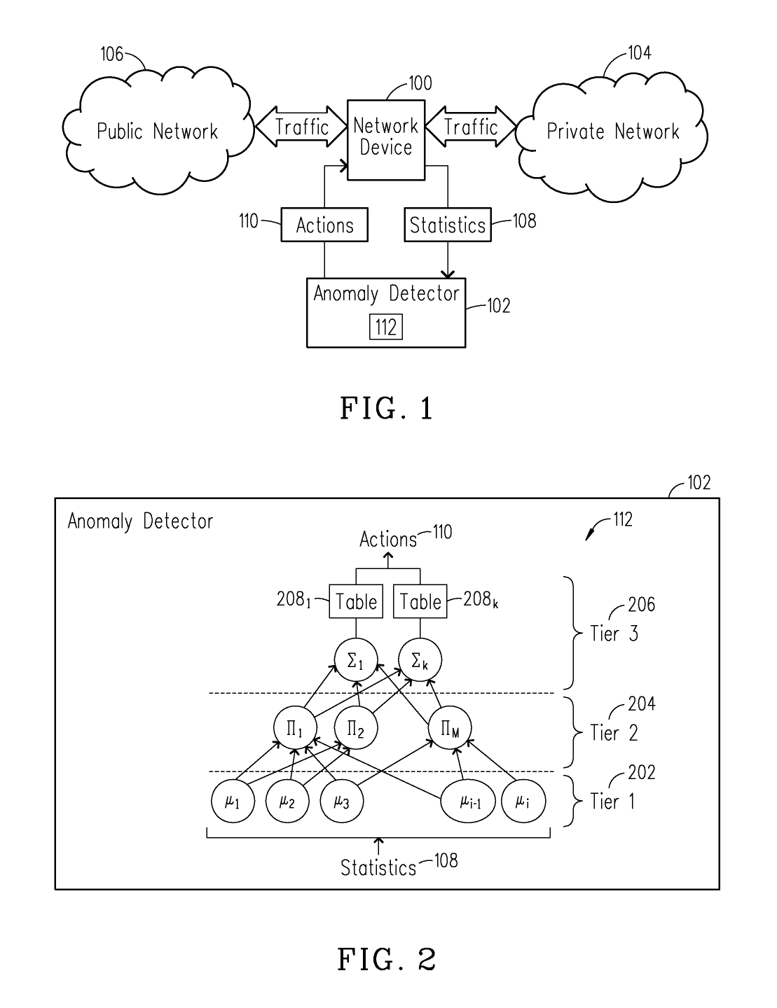

Referring to FIG. 1, there is shown a diagram which is used to help explain how a network device 100 can interface with an anomaly detector 102 that identifies symptoms of an attack and suggests escalating corrective actions which the network device 100 can then follow to address the symptoms of the attack in accordance with the present invention. In this exemplary scenario, the network device 100 by interfacing with the anomaly detector 102 (which can also be located within the network device 100) can protect a private network 104 from attacks and possible threats originating from a public network 106. Plus, the network device 100 by interfacing with the anomaly detector 102 can protect the private network 104 from attacks and potential abuses from its own users. A detailed discussion is provided next to explain how the anomaly detector 102 receives network statistics 108, process those network statistics 108 and then outputs corrective action(s) 110 which can be implemented by the network device 100 to protect the private network 104.

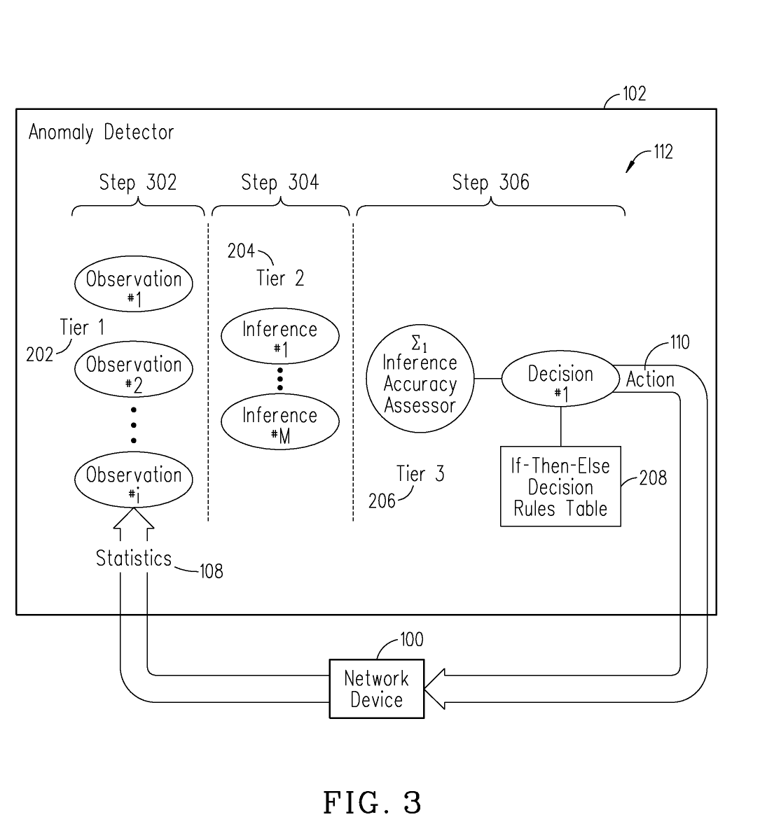

The anomaly detector 102 uses artificial intelligence to introduce a measure of adaptability in the anomaly detection process which is desirable because the nature of the newer network attacks (e.g., transmutable worms) is often convoluted, and more often, unknowable. In one embodiment, the anomaly detector 102 enables this measure of adaptability by using a form of artificial intelligence referred to herein as a type II fuzzy neural network 112 (see FIGS. 2 and 3). The type II fuzzy neural network 112 is able to use partial knowledge taken from the collected network statistics 108 to identify and track the symptoms of an attack before it suggests escalating corrective actions 110 to address the symptoms of the attack. Thus, the type II fuzzy neural network 112 does not need to deduce the root cause of an attack before it can detect an attack and suggest the corrective actions 110 needed to address the symptoms of the attack.

The type II fuzzy neural network 112 is different from a traditional neural network in that its conditions for learning are based on simple heuristics rather than complicated adaptive filters. These simple heuristics allow for undefined numerical errors in adaptation termed “fuzziness”. It is this “fuzzy” nature which allows the anomaly detector 102 to track an elusive problem by discovering a general trend without needing to have the precision of data that is required by a traditional neural network which uses complicated adaptive filters. An exemplary embodiment of a type II fuzzy neural network 112 which has a three-tiered control structure is discussed next with respect to FIGS. 2 and 3.

Referring to FIG. 2, there is shown a diagram of an exemplary three-tiered type II fuzzy neural network 112 which is used by the anomaly detector 102 to identify symptoms of an attack and to suggest escalating corrective actions which can be implemented until the symptoms of the attack begin to disappear in accordance with the present invention. As shown, the first tier 202 has multiple membership functions μ₁-μᵢ that collect statistics 108 about different aspects of the “health” of the network device 100 and process those numbers into metrics which have values that are between 0 and 1. The second tier 204 has multiple summers Π₁-Πₘ each of which interfaces with selected membership functions μ₁-μᵢ to obtain their metrics and then process/output a running sum (probabilistic, not numerical). The third tier 206 has multiple aggregators Σ₁-Σₖ each of which aggregates the sums from selected summers Π₁-Πₘ and computes a running average which is compared to fuzzy logic control rules located within a corresponding if-then-else table 208₁ and 208ₖ to determine a course of action 110 which the network device 100 can then follow to address the symptoms of an attack. In particular, the third tier 206 has multiple if-then-else tables 208₁ and 208ₖ each of which receives a running average from a respective aggregator Σ₁-Σₖ and based on that input performs an if-then-else analysis and then outputs the action 110 which the network device 100 can then implement to address the symptoms of an attack.

In one particular application, each membership function μ₁-μᵢ collects statistics 108 about a specific aspect of the network device 100 and then produces a single metric to represent the “health” of that particular aspect of the network device 100. This metric has a score between 0 and 1 which means that the corresponding membership function can be represented as μ ε {0 . . . 1}. The metric score is a fraction of a network statistic that the network device 100 is currently collecting, e.g. the number of packets across a particular interface, the number of bits across a particular interface, the number of http connections across a particular interface, etc . . . , against a theoretical maximum. For example: μ₁=throughput of port A=(number of bits transmitted by port A/second)/(link speed per second of port A). Thus, a higher score of a metric is more desirable than a lower score because the former is indicative of a superior state of health. As can be appreciated, there is no limit as to what type of aspect (statistic associated with the network device 100) a membership function can convey in its value of μ. Plus, the more precise that a network administrator defines the membership functions μ₁-μᵢ then the better the overall anomaly detector 102 is going to behave.

In the second tier 204, the metrics from selected membership functions μ₁-μᵢ are summed by one of the summers Π₁-Πₘ to produce an overall score μₒᵥₑᵣₐₗₗ. Because, certain individual membership functions μ₁-μᵢ can influence the overall score in different ways. The summers Π₁-Πₘ can model one or more of the individual membership functions μ₁-μᵢ with varying weights “w” so they have a desired compensatory effect on the overall score μₒᵥₑᵣₐₗₗ. In one example, this overall score μₒᵥₑᵣₐₗₗ can be calculated as follows (equation no. 1):

μₒᵥₑᵣₐₗₗ=(Π(μᵢ^{w(i)}*μ′ᵢ^{w(i)}))^{β}*(1−Π((1−μᵢ)^{w(i)}*(1−μ′ᵢ)^{w(i)}))^{γ}

where β=γ−1, μᵢ ε {0 . . . 1}, w(i)=ith weight for μᵢ

### The above equation happens to be a weighted, geometric mean of μᵢ and μ′ᵢ, where μᵢ is the ith factor affecting overall score μₒᵥₑᵣₐₗₗ, and μ′ᵢ is the rate of change of μᵢ, i.e. μ′ᵢ=dμᵢ/dt

In the third tier 206, selected ones of the weighted geometric means (overall scores μₒᵥₑᵣₐₗₗ) are summed by one of the aggregators Σ₁-Σₖ and the result is compared against a corresponding table 208₁ and 208ₖ of if-then-else actions. As shown, each aggregator Σ₁-Σₖ has only one table association and each table 208₁ and 208ₖ can been programmed to look for a specific attack/anomaly and to address the symptoms of that specific attack/anomaly. The following is an illustration of a sample table 208₁ and 208ₖ:

TABLE 1

| | | | | |
|---|---|---|---|---|
| If Sum₁ > Th1 | . . . | & if Sumₘ > Th4 | Then take | Else do |
| | | | action1 | nothing |
| If (Sum₁ < Th1 | . . . | & if (Sumₘ < Th4 & | Then take | Else do |
| & Sum₁ > Th2) | | sumₘ > Th5) | action2 | nothing |
| . . . | . . . | . . . | Then take | Else take |
| | | | action3 | action4 |
| If Sum₁ < Th3 | . . . | & if (Sumₘ < Th6) | Then take | Else take |
| | | | action5 | action6 |

Note: The table 208₁ and 208ₖ may also contain multiple actions, e.g. if (aggregator 1 > threshold 1) then do (action 1 and action 2 and action 3) else do (action 4 and action 5).

The actions 110 illustrated above are the steps which the networking device 100 can take to protect itself from an attack/anomaly. For example, the anomaly detector 102 may have detected potential network congestion on a particular interface in the network device 100 based on the current traffic pattern, i.e. when it's aggregator Σ₁ for congestion exceeds a particular threshold. If this aggregator's sum is in between a severe threshold and a mild threshold, then the action 110 triggered by the aggregator Σ₁ may be to have the networking device 100 mark all subsequent traffic with a low Differentiated Services Code Point (DSCP) priority. If the aggregator's sum exceeds the severe threshold, then the action 110 triggered by the aggregator Σ₁ may be to have the networking device 100 drop all of the subsequent traffic on the interface under congestion.

In another example, the networking device 100 may witness a suspiciously large number of HyperText Transfer Protocol (HTTP) requests, followed by large number of HTTP aborts from a small number of Internet Protocol (IP) addresses, in a predictive pattern and fixed interval. The anomaly detector 102 could track this pattern by aggregating both of these variables and then address this problem by outputting an action 110 which can be implemented by the networking device 100. In this example, it is assumed that the network operator has a-priori knowledge about this particular anomaly, thus they can properly configured the membership functions μ₁-μₙ (and also weight the membership functions μ₁-μₙ), the summers Π₁-Πₘ, the aggregators Σ₁-Σₖ and/or the if-then-else tables 208₁ and 208ₖ. Alternatively, the anomaly detector 102 could also be used to detect and address unexpected attacks/anomalies (this particular capability is discussed in more detail below).

As a sample embodiment, one can implement the three-tiered type II fuzzy neural network 112 on a piece of networking equipment 100, e.g., a layer 3 Ethernet switch 100, that already maintains a vast array of statistics. In this case, the tier 1 membership functions μ₁-μᵢ would periodically take these statistics and convert them into metrics/fractions which are feed into one or more tier 2 summers Π₁-Πₘ. For instance, one of the membership functions μ₁ could take the statistic related to the number of bits that passes an interface per second and divide this number against the port speed to produce a metric/fraction between {0 . . . 1} which would be indicative of the link utilization. In addition, to computing the first metric/fraction (μ₁), the tier 1 membership function μ₁ would also compute the time differential of that metric/fraction (μ₁′). To accomplish this, the membership function μ₁ could for instance calculate the slope of successive μ₁(t) points, extract an angular value trigonometrically, and divide the angle against 2π.

Thereafter, the tier 2 summers Π₁-Πₘ each receive a unique set of metrics/fractions (μ₁-μᵢ) and their corresponding time differential metrics/fractions (μ₁′-μᵢ′) and compute the weighted geometric mean μₒᵥₑᵣₐₗₗ based on equation no. 1 (for example). If desired, the summers Π₁-Πₘ can weight each of the metrics/fractions (μ₁-μᵢ) with a number between 0 and 1. The assigned weight of the metrics/fractions (μ₁-μᵢ) indicates the relative importance of the corresponding membership function μ₁-μᵢ. For example, if one wants to track network congestion, then link utilization would be weighted with a higher power than the number of open Transmission Control Protocol (TCP) connections. Of course, the type II fuzzy neural network 112 should converge regardless of the weights assigned to the membership functions μ₁-μᵢ. However, the type II fuzzy neural network 112 would adapt faster if the membership functions μ₁-μᵢ had properly chosen weights rather than if the membership functions μ₁-μᵢ had ill-chosen weights. Finally, the summers Π₁-Πₘ feed their outputs μₒᵥₑᵣₐₗₗₛ into selected ones of the tier 3 aggregators Σ₁-Σₖ each of which aggregates the received μₒᵥₑᵣₐₗₗₛ and computes a running average that is compared to fuzzy logic control rules (located in the corresponding if-then-else table 208, and 208ₖ) to determine a course of action 110 that the network device 100 can implement to address the symptoms of an attack.

Referring to FIG. 3, there is a diagram which is used to explain in a different way how the exemplary three-tiered type II fuzzy neural network 112 functions to help protect the private network 104 in accordance with the present invention. In step 302, the first tier entities 202 function to observe system status by collecting statistics and processing them into fractional values that can be manipulated by using fuzzy logic math. In step 304, the second tier entities 204 function to link diverse statistics to draw inferences. In step 306, the third tier entities 206 (only one Σ₁ and one if-then-else table 208, are shown) function to use a series of the hunches received from selected second tier entities 204 to make a decision about what action 110 the network device 100 can take to protect the private network 104.

An advantage of using a type II fuzzy neural network 112 is that one can train the type II fuzzy neural network 112 to learn about future attacks and network problems. For instance, when a network administrator anticipates a rash of new worm attacks on the public network 106, then they can unleash the suspected worm on an experimental network and use this mechanism to track the pattern of attack. Thereafter, the network administrator can program this newly learned pattern into a live anomaly detector 102 and then the private network 104 would be inoculated to such attacks. The operator can effect the inoculation in two ways: (1) they can modify the rule tables 208₁-208ₖ with actions that can shut down the impending attack; and/or (2) they can alter how the second tier 204 evaluates the observation(s) by updating the membership function(s) μ₁-μₙ (e.g., the weighting of an observation) or by adding new membership function(s).

In another example, if a network administrator wants to train the type II fuzzy neural network 112 to look for a new attack/anomaly, they could program one of the if-then-else tables 208₁ to take no action and then simply observe the outputs from the corresponding aggregator Σ₁. Then, they can design a specific set of actions which are tailored for that particular new attack/anomaly. In addition, if the type II fuzzy neural network 112 is trained to protect against specific threats, then the training process in itself along with the modifications of the fuzzy parameters can also help protect against never before seen attacks. These unexpected attacks only need to share some of the same elements associated with the known attacks for the fuzzy neural network 112 to decide that they are “bad” and enact a response. These elements can be measured and easily identified (for example they can be the packets per second of a specific traffic type) and the more of them the mechanism is aggregating, then the more varied the types of unexpected attacks which can be identified.

Although one embodiment of the present invention has been illustrated in the accompanying Drawings and described in the foregoing Detailed Description, it should be understood that the present invention is not limited to the embodiment disclosed, but is capable of numerous rearrangements, modifications and substitutions without departing from the spirit of the invention as set forth and defined by the following claims.

What is claimed is:

1. An anomaly detector comprising a type II fuzzy neural network that tracks symptoms of an attack and suggests escalating corrective actions until the symptoms of the attack begin to disappear.

2. The anomaly detector of claim 1, wherein said type II fuzzy neural network includes:
a three-tiered control structure having:
a first tier including a plurality of membership functions, where each membership function:
collects a network statistic; and
processes the collected statistic into a metric which is the collected statistic divided by a theoretical maximum of the collected statistic;
a second tier including a plurality of summmers, where each summer:
receives a unique set of metrics associated with the membership functions; and
calculates an average based on the unique set of metrics and on a rate of change of each of the metrics in the unique set; and
a third tier including at least one aggregator and at least one table, where each aggregator:
receives a unique set of the calculated averages; and
sums the unique set of the calculated averages; and
each table is used to analyze the summed calculated averages to determine if a course of action is needed to address the symptoms of the attack.

3. The anomaly detector of claim 2, wherein said collected network statistic includes:
a number of packets across a particular interface on a network device;
a number of bits across a particular interface on said network device; or
a number of HTTP connections across a particular interface on said network device.

4. The anomaly detector of claim 2, wherein said each summer calculates an average that is a weighted geometric calculated average.

5. The anomaly detector of claim 1, wherein said attack is a transmuting worm which implements a plurality of biological algorithms.

6. The anomaly detector of claim 1, wherein said attack is an unexpected attack.

7. The anomaly detector of claim 1, wherein said attack is an expected attack.

8. A method for addressing a symptom of an attack, said method comprising the steps of:
collecting a plurality of network statistics; and
processing each of the collected network statistics into a metric which is a fraction of the collected network statistic divided by a theoretical maximum of the collected network statistic;
calculating a plurality of averages each of which is based on a unique set of the metrics and a rate of change of the unique set of the metrics;
aggregating a unique set of the calculated averages; and
comparing the aggregated calculated averages to values in an if-then-else decision rules table to determine an action to address the symptom of the attack.

9. The method of claim 8, wherein said comparing step further includes revising the if-then-else decision rules table to better address the symptom of the attack after reviewing the collected network statistics, the calculated averages and/or the aggregated calculated averages.

10. The method of claim 8, wherein said collected network statistics includes:
a number of packets across a particular interface in said network device;
a number of bits across a particular interface in said network device; or
a number of HTTP connections across a particular interface in said network device.

11. The method of claim 8, wherein said attack is a transmuting worm which implements a plurality of biological algorithms.

12. A method for addressing a symptom of an attack, said method comprising the steps of:
collecting a plurality of network statistics;
processing each of the collected statistics into a fractional value;
drawing a plurality of inferences by summing a plurality of unique sets of the fractional values which are associated with the processed collected statistics;
aggregating the plurality of inferences; and
making a decision in view of the aggregated inferences and an if-then-else decision rules table to address the symptom of the attack.

13. The method of claim 12, wherein said collected network statistics includes:
a number of packets across a particular interface on a network device;
a number of bits across a particular interface on said network device; or
a number of HTTP connections across a particular interface on said network device.

14. The method of claim 12, wherein said attack is a transmuting worm which implements a plurality of biological algorithms.

15. A method for allowing a network administrator to identify a new anomaly and then address one or more symptoms that are associated with the new anomaly, said method comprising the steps of:
collecting a plurality of network statistics; and
processing each of the collected network statistics into a metric which is a fraction of the collected network statistic divided by a theoretical maximum of the collected network statistic;
calculating a plurality of averages each of which is based on a unique set of the metrics and a rate of change of the unique set of the metrics;
aggregating a unique set of the calculated averages; and
monitoring the collected network statistics, the calculated averages and/or the aggregated average to identify about the symptoms of the new anomaly;
revising an if-then-else decision rules table to include one or more actions that can be performed based on the aggregated average to address the symptoms of the new anomaly.

16. The method of claim 15, further comprising a step of weighting one or more of the collected statistics after monitoring the collected network statistics, the calculated averages and/or the aggregated average.

17. The method of claim 15, wherein said collected network statistics includes:
a number of packets across a particular interface on a network device;
a number of bits across a particular interface on said network device; or
a number of HTTP connections across a particular interface on said network device.

18. The method of claim 15, wherein said new anomaly is a transmuting worm which implements a plurality of biological algorithms.
